(19) United States
(12) Patent Application Publication
(10) Pub. No.: US 2026/0249275 A1
(43) Pub. Date: Aug. 27, 2026

(54) CATALYST NOBLE METAL PARTICLES

(71) Applicant: CATALER CORPORATION, Kakegawa-shi, Shizuoka (JP)

(72) Inventor: Takahiro NOGUCHI, Kakegawa-shi (JP)

(73) Assignee: CATALER CORPORATION, Kakegawa-shi, Shizuoka (JP)

(21) Appl. No.: 18/870,955

(22) PCT Filed: May 25, 2023
(86) PCT No.: PCT/JP2023/019442

§ 371 Date: Dec. 2, 2024

(30) Foreign Application Priority Data
Jun. 22, 2022 (JP) 2022-100625

(51) Int. Cl. B01J 23/44; B01D 53/94; B01J 35/45; B01J 37/02; B01J 37/03; B01J 37/04; F01N 3/28

(52) U.S. Cl. CPC B01J 23/44; B01D 53/94; B01J 35/45; B01J 37/0221; B01J 37/038; B01J 37/04; F01N 3/2803; B01D 2255/1021; B01D 2255/1023; B01D 2257/702; B01D 2258/01; F01N 2370/02

(57) ABSTRACT

Catalyst noble metal particles for exhaust gas purification are formed of an alloy that contains Pt and Pd, wherein the standard deviation σ_{COM} of the composition expressed by the ratio (Pt/(Pt+Pd)) of the mass of Pt to the total mass of Pt and Pd in the catalyst noble metal particles is 3.0% by mass or less.

### FIELD

The present invention relates to noble metal catalyst particles.

Exhaust gas emitted from internal combustion engines such as automobile engines contains hydrocarbons (HC), carbon monoxide (CO) and nitrogen oxides (NOx). These gases are released into the air after having been purified by an exhaust gas purification catalyst device installed in an exhaust system. An exhaust gas purification catalyst device generally has a construction with a catalyst coating layer disposed on partition walls of a honeycomb substrate, for example.

The catalyst coating layer of an exhaust gas purification catalyst device includes a noble metal catalyst as the active component for exhaust gas purification. The noble metal catalyst contains one or more elements selected from among Pt, Pd and Rh, for example, with Pt and Pd exhibiting HC and CO oxidation purification activity and Rh exhibiting NOx reduction purification catalytic activity.

HC includes saturated hydrocarbons and unsaturated hydrocarbons. Oxidizing purification of saturated hydrocarbons is generally more difficult.

In regard to oxidizing purification of HC, NPL 1 teaches that of Pt and Pd, Pt has more excellent oxidizing purification power for saturated hydrocarbons while Pd has more excellent oxidizing purification for unsaturated hydrocarbons.

Since the HC in exhaust gas of actual vehicles include both saturated hydrocarbons and unsaturated hydrocarbons, the catalyst coating layer of an exhaust gas purification catalyst device preferably comprises both Pt which has excellent oxidizing purification power for saturated hydrocarbons and Pd which has excellent oxidizing purification power for unsaturated hydrocarbons.

In PTL 1 it is stated that in a noble metal catalyst powder comprising Pt, Pd and Rd, the heat resistance and durability of the noble metal catalyst powder is increased if the standard deviation of the content of each element is adjusted to 20 mass % or lower.

PTL 2 describes a catalyst comprising both Pt and Pd, which is useful for treatment of vehicle exhaust gas, wherein the weight ratio of Pt to Pd is 20:1 to 1:20.

### CITATION LIST

### Patent Literature

[PTL 1] Japanese Unexamined Patent Publication No. 2011-123004
[PTL 2] Japanese Unexamined Patent Publication No. 2017-039121

### Non Patent Literature

[NPL 1] Applied Catalysis B. Environmental 251 (2019), pp 283-294

### SUMMARY

### Technical Problem

NPL 1 teaches that the oxidizing purification power of Pt for saturated hydrocarbons is impaired when alloyed with Pd.

The catalysts of PTLs 1 and 2 also have insufficient heat resistance and durability in harsh environments under alternating exposure to an oxidizing lean atmosphere and a reducing rich atmosphere, at high-temperatures of 1,000° C. and higher, as in vehicle exhaust gas channels, and their HC oxidizing purification activity is impaired with the passage of time.

The present invention has been completed in light of the circumstances described above.

It is an object of the invention to provide noble metal catalyst particles that exhibit sufficiently high heat resistance and durability even under harsh environments with alternating exposure to a lean atmosphere and rich atmosphere, and that exhibit a high level of oxidizing purification activity for both saturated hydrocarbons and unsaturated hydrocarbons, and especially for saturated hydrocarbons which are generally considered relatively difficult to purify.

### Solution to Problem

The present invention is as follows.

### <Aspect 1>

Noble metal catalyst particles which are noble metal particles of an exhaust gas purification catalyst comprising an alloy containing Pt and Pd, wherein the standard deviation COM of the composition represented by the ratio of the Pt mass with respect to the total mass of Pt and Pd (Pt/(Pt+Pd)) in the noble metal catalyst particles is 3.0 mass % or lower.

### <Aspect 2>

The noble metal catalyst particles according to aspect 1, wherein the standard deviation σ_{COM} of the composition is 2.5 mass % or lower.

### <Aspect 3>

The noble metal catalyst particles according to aspect 1 or 2, wherein the composition (Pt/(Pt+Pd)) is 1.0 mass % or greater and 70 mass % or lower.

### <Aspect 4>

The noble metal catalyst particles according to aspect 3, wherein the composition (Pt/(Pt+Pd)) is 3.0 mass % or greater and 40 mass % or lower.

### <Aspect 5>

The noble metal catalyst particles according to any one of aspects 1 to 4, wherein the mean particle size of the noble metal catalyst particles is 2.0 nm or greater and 5.0 nm or smaller.

### <Aspect 6>

The noble metal catalyst particles according to any one of aspects 1 to 5, wherein the standard deviation σ_{rad} of the particle diameters of the noble metal catalyst particles is 2.0 nm or lower.

### <Aspect 7>

The noble metal catalyst particles according to aspect 6, wherein the standard deviation σ_{rad} of the particle diameters of the noble metal catalyst particles is 1.5 nm or lower.

### <Aspect 8>

The noble metal catalyst particles according to any one of aspects 1 to 7, wherein the coefficient of variation of the composition of the catalyst metal particles is 0.45 or lower.

### <Aspect 9>

A method for producing noble metal catalyst particles according to any one of aspects 1 to 8, wherein the method comprises reacting a solution containing a Pt precursor and a Pd precursor with a solution containing an organic base, in a micro reactor.

### <Aspect 10>

The production method according to aspect 9, wherein the organic base is selected from among amines and quaternary ammonium salts.

### <Aspect 11>

The production method according to aspect 9 or 10, wherein the amount of the organic base is 0.5 times or greater and 10 times or less with respect to the total molar amount of Pt and Pd in the solution containing the Pt precursor and Pd precursor.

### <Aspect 12>

A supported catalyst for exhaust gas purification, comprising:
inorganic oxide carrier particles, and
noble metal catalyst particles according to any one of aspects 1 to 8, supported on the inorganic oxide carrier particles.

### Advantageous Effects of Invention

The present invention provides noble metal catalyst particles that exhibit sufficiently high heat resistance and durability even under harsh environments with alternating exposure to a lean atmosphere and rich atmosphere, and that exhibit a high level of oxidizing purification activity for both saturated hydrocarbons and unsaturated hydrocarbons.

### BRIEF DESCRIPTION OF DRAWINGS

FIG. 1 is a graph showing the relationship between composition standard deviation σ_{COM} and propane 50% purification temperature (T50(C₃H₈)) for the noble metal catalyst particles of Examples 1 to 5 and Comparative Examples 1 to 3.

FIG. 2 is a graph showing the relationship between composition (Pt/(Pt+Pd) ratio) and propane 50% purification temperature (T50(C₃H₈)) for the noble metal catalyst particles of Examples 7 to 12 and Comparative Examples 5 to 11.

### DESCRIPTION OF EMBODIMENTS

### <Noble Metal Catalyst Particles>

The noble metal catalyst particles of the invention are noble metal particles of an exhaust gas purification catalyst comprising an alloy containing Pt and Pd, wherein the standard deviation σ_{COM} of the composition represented by the ratio of the Pt mass with respect to the total mass of Pt and Pd (Pt/(Pt+Pd)) in the noble metal catalyst particles is 3.0 mass % or lower.

The present inventors considered the causes of deteriorating catalytic activity, and especially oxidizing purification activity for saturated hydrocarbons, by known noble metal catalyst particles of the prior art comprising Pt and Pd when under alternating exposure to a lean atmosphere and rich atmosphere at high temperature.

As a result it was found that Pt has low durability in a lean atmosphere, such that Pt at the Pt-rich parts of the noble metal catalyst particles preferentially undergo rapid oxidative degradation, resulting in notable impairment of the overall catalytic activity of the noble metal catalyst particles.

According to the invention, compounding of Pt and Pd in the noble metal catalyst particles is made uniform in order to minimize the proportion of Pt-rich parts that preferentially undergo oxidative degradation in a lean state. This inhibits oxidative degradation of Pt in lean atmospheres, allowing the oxidizing purification activity for saturated hydrocarbons to be maintained for long periods. The oxidizing purification activity for unsaturated hydrocarbons is also unimpaired with the construction of the invention.

The noble metal catalyst particles of the invention are therefore able to exhibit sufficiently high heat resistance and durability even under harsh environments, and can exhibit a high level of oxidizing purification activity for both saturated hydrocarbons and unsaturated hydrocarbons.

Such noble metal catalyst particles having a low composition standard deviation σ_{COM} may be produced, for example, by a method that comprises reacting a solution containing a Pt precursor and a Pd precursor with a solution containing an organic base, in a micro reactor.

### <Composition of Noble Metal Catalyst Particles>

The noble metal catalyst particles of the invention are composed of an alloy of Pt and Pd. The alloy may also include noble metals other than Pt and Pd (such as Rh). However, the noble metal catalyst particles may essentially lack any metals other than Pt and Pd.

That the noble metal catalyst particles of the invention essentially lack any metals other than Pt and Pd includes cases where the proportion of the mass of metals other than Pt and Pd with respect to the total mass of the noble metal catalyst particles is 5 mass % or lower, 3 mass % or lower, 1 mass % or lower, 0.5 mass % or lower or 0.1 mass % or lower, or even 0 mass %.

The composition of the noble metal catalyst particles is represented herein as a percentage for the ratio of Pt mass with respect to the total mass of Pt and Pd (Pt/(Pt+Pd)).

The noble metal catalyst particles of the invention exhibit high HC oxidizing purification power, and especially oxidizing purification power for saturated hydrocarbons, in a relatively wide compositional range. Catalyst metal particles of the prior art have had a limited specific narrow compositional range in which the desired HC oxidizing purification power is exhibited. However, the noble metal catalyst particles of the invention exhibit a high level of HC purification in a wide compositional range, thus providing a significant advantage in terms of the degree of freedom for catalyst design.

From the viewpoint of ensuring high oxidizing purification activity for saturated hydrocarbons, the composition of the noble metal catalyst particles represented by Pt/(Pt+Pd) (mass %) may be 1.5 mass % or greater, 2.0 mass % or greater, 3.0 mass % or greater, 5.0 mass % or greater, 10 mass % or greater, 12 mass % or greater, 15 mass % or greater, 17 mass % or greater or 20 mass % or greater.

From the viewpoint of ensuring high oxidizing purification activity for unsaturated hydrocarbons, on the other hand, the composition of the noble metal catalyst particles (mass %) may be 70 mass % or lower, 65 mass % or lower, 60 mass % or lower, 55 mass % or lower, 50 mass % or lower, 45 mass % or lower, 40 mass % or lower, 35 mass % or lower or 30 mass % or lower.

The composition of the noble metal catalyst particles (mass %) will typically be 1.0 mass % or greater and 70 mass % or lower, or 3.0 mass % or greater and 40 mass % or lower.

The composition of the noble metal catalyst particles can be determined by scanning transmission electron microscope-energy dispersive X-ray spectroscopic analysis (STEM-EDX).

Specifically, the composition of the noble metal catalyst particles is determined by elemental analysis by EDX for each of 50 randomly extracted noble metal catalyst particles, and the number average is calculated as the composition of the noble metal catalyst particles.

The STEM-EDX analysis may be carried out for the noble metal catalyst particles, or the STEM-EDX analysis may be carried out for the supported catalyst when the noble metal catalyst particles are in the form of a supported catalyst supported on a carrier. When STEM-EDX analysis is carried out for a supported catalyst, the EDX information in the STEM image for the part corresponding to the noble metal catalyst particles may be used.

### <Standard Deviation of Noble Metal Catalyst Particle Composition>

The noble metal catalyst particles of the invention have a composition standard deviation σ_{COM} of 3.0 mass % or lower.

A composition standard deviation σ_{COM} of 3.0 mass % or lower for the noble metal catalyst particles of the invention will ensure a uniform degree of compounding of Pt and Pd in the noble metal catalyst particles. This will produce a very low proportion of Pt-rich parts that preferentially undergo oxidative degradation in a lean state, thus inhibiting oxidative degradation of Pt in a lean atmosphere and helping to exhibit high stability and durability.

The composition standard deviation σ_{COM} of the noble metal catalyst particles may be 2.9 mass % or lower, 2.7 mass % or lower, 2.5 mass % or lower, 2.2 mass % or lower or 2.0 mass % or lower. While a lower composition standard deviation σ_{COM} is preferred, even very low values do not result in unlimited increase in the exhaust gas purification power of the noble metal catalyst particles. In order to exhibit the effect of the invention, the composition standard deviation σ_{COM} of the noble metal catalyst particles may be 0.1 mass % or greater, 0.5 mass % or greater, 1.0 mass % or greater, 1.2 mass % or greater, 1.5 mass % or greater or 2.0 mass % or greater.

The composition standard deviation σ_{COM} of the noble metal catalyst particles can be calculated from the composition of the noble metal catalyst particles determined by scanning transmission electron microscope-energy dispersive X-ray spectroscopic analysis (STEM-EDX) as mentioned above.

The recommended range for the composition standard deviation σ_{COM} of the noble metal catalyst particles depends on the initial value measured immediately after preparing the noble metal catalyst particles of the invention. The noble metal catalyst particles of the invention show a tendency toward smaller composition standard deviation σ_{COM} as their durability increases with use. This does not impair the effect of the invention, however.

### <Coefficient of Variation of Noble Metal Catalyst Particle Composition>

For the catalyst metal particles of the invention, the coefficient of variation of the composition may be 0.45 or lower, being defined as the composition standard deviation σ_{COM} determined as explained above, divided by the average composition. If the coefficient of variation of the composition is 0.45 or lower, in addition to a composition standard deviation σ_{COM} of 3.0 mass % or lower for the noble metal catalyst particles of the invention, this will ensure a high level of uniformity for compounding of Pt and Pd in the noble metal catalyst particles.

The coefficient of variation of the composition of the catalyst metal particles of the invention may be 0.40 or lower, 0.30 or lower or 0.20 or lower. In order to exhibit the effect of the invention, the coefficient of variation of the composition of the noble metal catalyst particles may be 0.02 or higher, 0.04 or higher, 0.06 or higher or 0.10 or higher.

### <Particle Diameter of Noble Metal Catalyst Particles>

The particle diameter of the catalyst metal particles of the invention may be somewhat larger from the viewpoint of maintaining composition stability of the alloy containing Pt and Pd. From this viewpoint, the mean particle size of the noble metal catalyst particles may be 1.5 nm or larger, 2.0 nm or larger, 2.5 nm or larger, 3.0 nm or larger or 3.5 nm or larger.

A smaller value is preferred, on the other hand, from the viewpoint of increasing the specific surface area of the catalyst metal particles for more active sites for exhaust gas purification to be exposed on the surfaces. From this viewpoint, the mean particle size of the noble metal catalyst particles may be 10.0 nm or smaller, 8.0 nm or smaller, 6.0 nm or smaller or 4.0 nm or smaller.

The mean particle size of the noble metal catalyst particles of the invention will typically be 2.0 nm or larger and 6.0 nm or smaller.

The mean particle size of the noble metal catalyst particles of the invention can be calculated from a STEM image, for example.

The recommended range for the mean particle size of the noble metal catalyst particles depends on the initial value measured immediately after preparing the noble metal catalyst particles of the invention. The noble metal catalyst particles of the invention show a tendency toward larger mean particle size as their durability increases with use. This does not impair the effect of the invention, however.

### <Standard Deviation of Noble Metal Catalyst Particle Diameter>

The noble metal catalyst particles of the invention do not need to include fine particles and coarse particles, from the viewpoint of obtaining high catalytic activity and exhibiting both heat resistance and durability. From this viewpoint, the standard deviation σ_{rad} for the particle diameter of the noble metal catalyst particles may be 1.2 nm or lower, 1.0 nm or lower, 0.8 nm or lower or 0.6 nm or lower. In order to exhibit the effect of the invention, the standard deviation σ_{rad} for the particle diameter of the noble metal catalyst particles may be 0.1 nm or higher, 0.2 nm or higher, 0.3 nm or higher or 0.4 nm or higher.

The recommended range for the standard deviation σ_{rad} for the particle diameter of the noble metal catalyst particles depends on the initial value measured immediately after preparing the noble metal catalyst particles of the invention. The noble metal catalyst particles of the invention show a tendency toward higher standard deviation σ_{rad} for the particle diameter as their durability increases with use. This does not impair the effect of the invention, however.

### <Supported Catalyst for Exhaust Gas Purification>

Another aspect of the invention provides a supported catalyst for exhaust gas purification, comprising:

inorganic oxide carrier particles, and noble metal catalyst particles of the invention, supported on the inorganic oxide carrier particles.

The inorganic oxide carrier particles may be particles composed of oxides including one or more metal elements selected from among rare earth elements other than Al, Ti, Si, Zr, Ce and Ce. When the inorganic oxide carrier particles are composed of oxides of two or more metal elements, the oxides may be a mixture of metal oxides, or a complex oxide, or a mixture of the same.

In addition to oxides of these metal elements, the inorganic oxide carrier particles may also comprise oxides of one or more metal elements selected from among alkali metals and alkaline earth metals.

The particle diameter of the inorganic oxide carrier particles may be set as appropriate for the intended supported catalyst for exhaust gas purification. The particle diameter of the inorganic oxide carrier particles may be 0.1 μm or greater, 0.5 μm or greater or 1.0 μm or greater, and 20.0 μm or smaller, 15.0 μm or smaller or 10.0 μm or smaller, for example.

The loading ratio of the noble metal catalyst particles in the supported catalyst for exhaust gas purification of the invention may be 0.1 mass % or greater, 0.3 mass % or greater or 0.5 mass % or greater, and 5.0 mass % or lower, 3.0 mass % or lower or 2.0 mass % or lower, as the mass ratio of the noble metal catalyst particles with respect to the total mass of the supported catalyst for exhaust gas purification.

### <Exhaust Gas Purification Catalyst Device>

Yet another aspect of the invention provides an exhaust gas purification catalyst device comprising:
a substrate, and
a catalyst coating layer on the substrate,
   wherein noble metal catalyst particles of the invention are included in the catalyst coating layer.

### <Substrate>

The substrate to be used for the exhaust gas purification catalyst device of the invention may be a substrate having a plurality of cell flow channels divided by partition walls, and it may be a honeycomb substrate used in exhaust gas purification catalyst devices of the prior art. The partition walls of the substrate may also have pores allowing fluid communication between adjacent exhaust gas flow paths, or it may lack such pores.

The constituent material of the substrate may be a fire-resistant inorganic oxide such as cordierite, or a metal, for example. The substrate may be either a straight flow type or a wall flow type.

The substrate for the method for producing an exhaust gas purification catalyst device of the invention may typically be a cordierite straight flow type monolith honeycomb substrate, a cordierite wall flow type monolith honeycomb substrate, or a metal honeycomb substrate, for example.

### <Catalyst Coating Layer>

The catalyst coating layer of the exhaust gas purification catalyst device of the invention comprises noble metal catalyst particles of the invention.

The noble metal catalyst particles in the catalyst coating layer may be in the form of a supported catalyst for exhaust gas purification, supported on inorganic oxide carrier particles, for example.

The catalyst coating layer of the exhaust gas purification catalyst device of the invention may also contain other optional components in addition to noble metal catalyst particles or a supported catalyst for exhaust gas purification. Such optional components may be inorganic oxide particles other than the inorganic oxide carrier particles, and binders, for example.

The exhaust gas purification catalyst device of the invention can be produced by any desired method. A typical production method is a method in which a catalyst coating layer-forming slurry containing noble metal catalyst particles or a supported catalyst for exhaust gas purification, with optional components as necessary, is coated onto a substrate and then fired.

The catalyst coating layer-forming slurry may be a publicly known composition, except for the noble metal catalyst particles or supported catalyst for exhaust gas purification of the invention. Coating of the catalyst coating layer-forming slurry on the substrate and firing may each be carried out by publicly known methods, or by methods based on them.

### <Method for Producing Noble Metal Catalyst Particles>

The noble metal catalyst particles of the invention may be produced, for example, by a method that comprises reacting a solution containing a Pt precursor and a Pd precursor with a solution containing an organic base, in a micro reactor.

By reacting a solution containing a Pt precursor and Pd precursor with a solution containing an organic base, it is possible to produce a coprecipitate containing the Pt precursor and Pd precursor. Noble metal catalyst particles are obtained by firing the coprecipitate in the presence or in the absence of suitable inorganic oxide carrier particles. When the coprecipitate is fired in the presence of inorganic oxide carrier particles, a supported catalyst for exhaust gas purification is obtained with the noble metal catalyst particles supported on the inorganic oxide carrier particles. Noble metal catalyst particles are obtained when firing of the coprecipitate is carried out in the absence of inorganic oxide carrier particles.

### <Solution Containing Pt Precursor and Pd Precursor>

The Pt precursor may be a solvent-soluble salt, and specifically a nitrate, sulfate or complex salt of Pt, for example. The Pd precursor may likewise be a solvent-soluble salt, and specifically a nitrate, sulfate or halide of Pd, for example.

The proportion of Pt and Pd in the solution may be set as appropriate depending on the desired proportion of Pt and Pd in the noble metal catalyst particles.

The solvent of the solution containing the Pt precursor and Pd precursor is not particularly restricted so long as it can dissolve the Pt precursor and Pd precursor. The solvent may be one or more selected from among water and water-soluble organic solvents, for example, but will typically be water.

The concentration of Pt and Pd in the solution may be set as appropriate in a range in which the Pt precursor and Pd precursor dissolve, and for example, the total concentration of the Pt precursor and Pd precursor may be 1 mass % or greater or 5 mass % or greater, and 25 mass % or lower or 20 mass % or lower.

### <Solution Containing Organic Base>

The organic base may be an amine, a quaternary ammonium salt, a nitrogen atom-containing heterocyclic compound or a basic amino acid.

An amine may be pyridine or triethylamine, for example;
a quaternary ammonium salt may be tetramethylammonium hydroxide or tetraethylammonium hydroxide, for example;
a nitrogen atom-containing heterocyclic compound may be diazabicycloundecene, 1,8-bis(dimethylamino)naphthalene or 1,8-bis(diethylamino)naphthalene, for example; and
a basic amino acid may be lysine, arginine, histidine or tryptophan, for example.

An organic base may be one or more selected from among amines and quaternary ammonium salts.

The solvent of the solution containing the organic base is not particularly restricted so long as it can dissolve the organic base. The solvent may be one or more selected from among water and water-soluble organic solvents, for example, but will typically be water.

The concentration of the organic base in the solution may be set as appropriate in a range in which the organic base dissolves, and for example, the total concentration of the organic base may be 5 mass % or greater or 10 mass % or greater, and 30 mass % or lower or 25 mass % or lower.

### <Proportion of Solvents in Solution Containing Pt Precursor and Pd Precursor and in Solution Containing Organic Base>

The proportion of solvents used for the solution containing the Pt precursor and Pd precursor and the solution containing the organic base may be set within a range such that the coprecipitation reaction for the Pt precursor and Pd precursor proceeds rapidly and uniformly.

The proportion of the solvents used for the solution containing the Pt precursor and Pd precursor and the solution containing the organic base may be a molar proportion of 0.5 times or greater, 1 or greater, 2 times or greater, 3 times or greater, 4 times or greater or 5 times or greater, and 12 times or less, 10 times or less, 8 times or less, 6 times or less or 5 times or less, as the proportion of the molar amount of the organic base in the solution containing the organic base with respect to the molar amount of the total of Pt and Pd in the solution containing the Pt precursor and Pd precursor.

The proportion of moles of the organic base with respect to total moles of Pt and Pd will typically be 0.5 times or greater and 10 times or less.

### <Micro Reactor>

In the method for producing the noble metal catalyst particles of the invention, a solution containing a Pt precursor and a Pd precursor is reacted with a solution containing an organic base, in a micro reactor.

A micro reactor, as referred to herein, is a flow-through reactor having a volume (reaction volume) of 1.0 mL or lower, 0.5 mL or lower, 0.3 mL or lower, 0.2 mL or lower or 0.1 mL or lower at the reaction site (mixer) where the first reaction stock solution (the solution containing the Pt precursor and Pd precursor) and the second reaction stock solution (the solution containing the organic base) are contacted.

The reaction volume in the micro reactor may be 0.01 mL or greater, 0.03 mL or greater, 0.05 mL or greater or 0.07 mL or greater.

The reaction site model may be as desired, with an appropriate system such as a T-type, J-type, V-type, interdigital triangle type, interdigital rectangle type, super focus type, cyclone type, pillar type, disc type, impact type, capillary type or slit type.

The heat transfer coefficient at the reaction site of the micro reactor may be relatively high, such as 1 MW/(m³·K) or higher and 500 MW/(m³·K) or lower. Setting the heat transfer coefficient at the reaction site of the micro reactor within this range will allow efficient escape of the heat of reaction generated upon contact between the first reaction stock solution and second reaction stock solution. This will avoid local temperature increase and ensure homogeneity of the reaction.

The feed rate of the reaction stock solution to the micro reactor may be 50 mL/min or greater, 75 mL/min or greater, 100 mL/min or greater, 125 mL/min or greater or 150 mL/min or greater, and 500 mL/min or lower, 450 mL/min or lower, 400 mL/min or lower, 350 mL/min or lower, 300 mL/min or lower or 250 mL/min or lower, as the total feed rate of the first reaction stock solution and second reaction stock solution.

The reaction temperature may be a temperature at which the first reaction stock solution and second reaction stock solution are in the liquid state, such as 0° C. or higher, 10° C. or higher, 20° C. or higher, 30° C. or higher, 40° C. or higher, 50° C. or higher or 60° C. or higher, and 100° C. or lower, 90° C. or lower, 80° C. or lower, 70° C. or lower, 60° C. or lower, 50° C. or lower or 40° C. or lower.

The residence time of the first reaction stock solution and second reaction stock solution at the reaction site of the micro reactor is extremely short. Consequently, the reaction temperature may be controlled by adjusting the temperature of the first reaction stock solution and second reaction stock solution to a predetermined temperature before introduction into the micro reactor.

Noble metal catalyst particles or a supported catalyst for exhaust gas purification of the invention can thus be obtained. The obtained noble metal catalyst particles or supported catalyst for exhaust gas purification may be used after sorting as necessary.

### EXAMPLES

### Example 1

### (1) Preparation of Noble Metal Particles of Exhaust Gas Purification Catalyst

### (i) Preparation of Coprecipitate Slurry

A platinum nitrate aqueous solution containing platinum nitrate at 0.0909 g (0.466 mmol) in terms of Pt metal and a palladium nitrate aqueous solution containing palladium nitrate at 0.909 g (8.54 mmol) in terms of Pd metal were mixed to obtain reaction stock solution A. The total amount of Pt and Pd in terms of metal in the reaction stock solution A was 1.0 g (9.01 mmol), and the compositional ratio of Pt/(Pt+Pd) was 9.10 mass %.

Separately, a TEAH aqueous solution was prepared containing 10.61 g (72.07 mmol) of tetraethylammonium hydroxide (TEAH), for use as reaction stock solution B.

Reaction stock solution A and reaction stock solution B were contacted using a disc type micro reactor where the reaction site (mixer) was a gap between a fixed disc and a rotating disc. The reaction stock solution A and reaction stock solution B were fed to the micro reactor and reaction was conducted by contact in the reaction site of the micro reactor, producing a coprecipitate-containing slurry (coprecipitate slurry). The conditions in the micro reactor were as follows.
Reaction volume: 85 mm³ (0.085 mL)
Disc diameter: 100 mm
Rotating disc rotational speed: 1,000 rpm
Temperatures of reaction stock solutions A and B: both 50° C.
Flow rates of reaction stock solutions A and B: Total 200 mL/min for both

For Example 1, the reaction was conducted while adjusting the supply rates of the reaction stock solutions A and B so that the molar ratio of TEAH/(Pt+Pd) was 8.0.

### (ii) Supporting Noble Metal Catalyst Particles on Oxide Support

The coprecipitate slurry obtained as described above was added to a slurry obtained by mixing alumina powder and ion-exchanged water, and the mixture was stirred for 30 minutes. The solid was then filtered out and dried at 120° C. for 8 hours, after which it was fired in an electric furnace at 500° C. for 1 hour, supporting the noble metal catalyst particles composed of Pt—Pd alloy on the alumina to obtain a supported catalyst for exhaust gas purification. The amount of ion-exchanged water used was adjusted during this time so that the solid concentration in the reaction mixture was 30 mass %. The coprecipitate slurry used contained the Pt precursor at 0.0909 g (0.466 mmol) in terms of Pt metal and the Pd precursor at 0.909 g (8.54 mmol) in terms of Pd metal, with respect to 99.0 g of alumina powder.

### (2) Evaluating Particle Diameter and Standard Deviation of Particle Diameter of Noble Metal Catalyst Particles, and Standard Deviation of Composition (Initial Values)

The noble metal catalyst particles in the obtained supported catalyst for exhaust gas purification were examined by scanning transmission electron microscope-energy dispersive X-ray spectroscopic analysis (STEM-EDX) to determine the standard deviation for the particle diameter and particle diameter, and the standard deviation for the composition.

Specifically, the obtained supported catalyst for exhaust gas purification was observed by STEM and the particle diameters of 50 randomly extracted noble metal catalyst particles were measured, determining the number-average value as the mean particle size and calculating the standard deviation σ_{rad} for the particle diameter. Elemental analysis of the same 50 noble metal catalyst particles was conducted by EDX, and the composition of each noble metal catalyst particle was determined, calculating the standard deviation σ_{com} for Pt/(Pt+Pd).

The mean particle size of the noble metal catalyst particles in the supported catalyst for exhaust gas purification immediately after preparation in Example 1 was 3.44 nm, the standard deviation σ_{rad} of the particle diameter was 0.62 nm, and the standard deviation σ_{com} for Pt/(Pt+Pd) was 2.22 mass %.

### (3) Evaluation of Supported Catalyst for Exhaust Gas Purification

### (i) Heat Endurance Treatment

A 10 g portion of the obtained powder of the supported catalyst for exhaust gas purification was placed in a tubular durable furnace with a diameter of 65 mm and a length of 900 mm (3,000 mL capacity), and heat endurance treatment was carried out under the following conditions.

First, the catalyst temperature was increased from 20° C. to 1,050° C. over a period of 5 hours at a temperature-elevating rate of about 3.43° C./min, while flowing N₂ gas through at a rate of 10 L/min. The catalyst temperature was then kept at 1,050° C. while switching the model gas between rich atmosphere and lean atmosphere every 5 minutes, with flow through at a rate of 10 L/min, for 5 hours of heat endurance treatment. The catalyst temperature was also lowered from 1,050° C. to 20° C. over a period of 5 hours at a temperature-lowering rate of about 3.43° C./min, while flowing N₂ gas through at a rate of 10 L/min.

The compositions of the model gases of the rich atmosphere and lean atmosphere used for the heat endurance treatment were as follows.

### <Model Gas for Rich Atmosphere>

CO: 2 vol %
H₂O: 10 vol %
N₂: balance

### <Model Gas for Lean Atmosphere>

02:5 vol %
H₂O: 10 vol %
N₂: balance

### (ii) Exhaust Gas Purification Test

After compression molding of the supported catalyst for exhaust gas purification following the heat endurance treatment, the powder was pulverized and sorted to form amorphous pellets with sizes of 1.0 to 2.0 mm. A 1.0 g portion of the obtained pellets was placed into a tubular reactor with a diameter of 10.0 mm and a length of 55 mm (4.3 mL capacity). After pretreatment for 5 minutes at a catalyst temperature of 700° C. while flowing exhaust model gas through at a rate of 8 L/min, it was cooled to 80° C. while maintaining circulation of the exhaust model gas.

The catalyst temperature was then increased at a temperature-elevating rate of 35° C./min while maintaining flow of exhaust model gas, recording the respective temperatures at which the purification rates of propane and propylene in the model gas reached 50% as the propane 50% purification temperature (T50(C₃H₈)) and the propylene 50% purification temperature (T50(C₃H₆))

The composition of the exhaust model gas used in the exhaust gas purification test was as follows.

### <Exhaust Model Gas>

Propane (C₃H₈)): 600 ppm
Propylene (C₃H₆): 2,400 ppm
CO: 11.1 vol %
02:0.77 vol %
NO: 2,111 ppm
CO: 5,600 ppm
H₂: 2,000 ppm
H₂O: 10 vol %
N₂: balance

The “ppm” units for the component concentrations in the exhaust model gas are volume-based.

For the supported catalyst for exhaust gas purification of Example 1, the propane 50% purification temperature (T50(C₃H₈)) was 325.0° C. and the propylene 50% purification temperature (T50(C₃H₆)) was 262.9° C.

(iii) Evaluating Particle Diameter and Standard Deviation of Particle Diameter of Noble Metal Catalyst Particles, and Standard Deviation of Composition (after Endurance)

The particle diameter and standard deviation of the particle diameter for the supported catalyst for exhaust gas purification after heat endurance treatment, and the standard deviation of the composition, were examined by the same method as described for “(2) Evaluating particle diameter and standard deviation of particle diameter of noble metal catalyst particles, and standard deviation of composition (initial values)”. The mean particle size of the noble metal catalyst particles in the supported catalyst for exhaust gas purification immediately after endurance in Example 1 was 31.0 nm, the standard deviation σ_{rad} of the particle diameter was 11.3 nm, and the standard deviation σ_{com} for Pt/(Pt+Pd) was 0.58 mass %.

### Examples 2 to 5

Supported catalysts for exhaust gas purification were prepared in the same manner as Example 1, except that for “(i) Preparation of coprecipitate slurry”, the amount of TEAH in the reaction stock solution B was changed as shown in Table 1 and the molar ratio of TEAH/(Pt+Pd) was changed as shown in Table 1, and each was evaluated. The results are shown in Table 2.

For “(ii) Supporting noble metal catalyst particles on oxide support”, the amount of ion-exchanged water used was adjusted so that the solid concentration in the reaction mixture was 30 mass %.

### Comparative Examples 1 to 3

Supported catalysts for exhaust gas purification were prepared in the same manner as Example 1, except that for “(i) Preparation of coprecipitate slurry”, a flask was used instead of a micro reactor, the amounts of reaction stock solution A and reaction stock solution B used were changed and the molar ratio of TEAH/(Pt+Pd) was changed as shown in Table 1, and each was evaluated. The results are shown in Table 2.

For “(ii) Supporting noble metal catalyst particles on oxide support”, the amount of ion-exchanged water used was adjusted so that the solid concentration in the reaction mixture was 30 mass %.

For Comparative Example 3, the exhaust gas purifying catalyst was prepared with reaction stock solution A supplied directly to “(ii) Supporting noble metal catalyst particles on oxide support”, without using reaction stock solution B.

### Example 6

A supported catalyst for exhaust gas purification was prepared in the same manner as Example 3, except that a TMAH aqueous solution comprising 3.29 g (36.04 mmol) of tetramethylammonium hydroxide (TMAH) was used as reaction stock solution B, and the catalyst was evaluated. The results are shown in Table 4.

### Comparative Example 4

A supported catalyst for exhaust gas purification was prepared in the same manner as Comparative Example 2, except that a TMAH aqueous solution comprising 3.29 g (36.04 mmol) of tetramethylammonium hydroxide (TMAH) was used as reaction stock solution B, and the catalyst was evaluated. The results are shown in Table 4.

### Reference Example 1 and Examples 7 to 12

Supported catalysts for exhaust gas purification were prepared in the same manner as Example 1, except that for “(i) Preparation of coprecipitate slurry”, the amounts of platinum nitrate and palladium nitrate in reaction stock solution A were changed as shown in Table 5, the mass ratio of Pt/(Pt+Pd) was as shown in Table 5 while keeping the total amount of Pt and Pd at 1.0 g in terms of metal, the amount of TEAH in reaction stock solution B was changed as shown in Table 5 and the molar ratio of TEAH/(Pt+Pd) was adjusted to 4.0, and each was evaluated. The results are shown in Table 6.

For “(ii) Supporting noble metal catalyst particles on oxide support”, the amount of ion-exchanged water used was adjusted so that the solid concentration in the reaction mixture was 30 mass %.

### Comparative Examples 5 to 11

Supported catalysts for exhaust gas purification were prepared in the same manner as Reference Example 1 and Examples 7 to 12, respectively, except that for “(i) Preparation of coprecipitate slurry”, a flask was used instead of a micro reactor, and each was evaluated. The results are shown in Table 6.

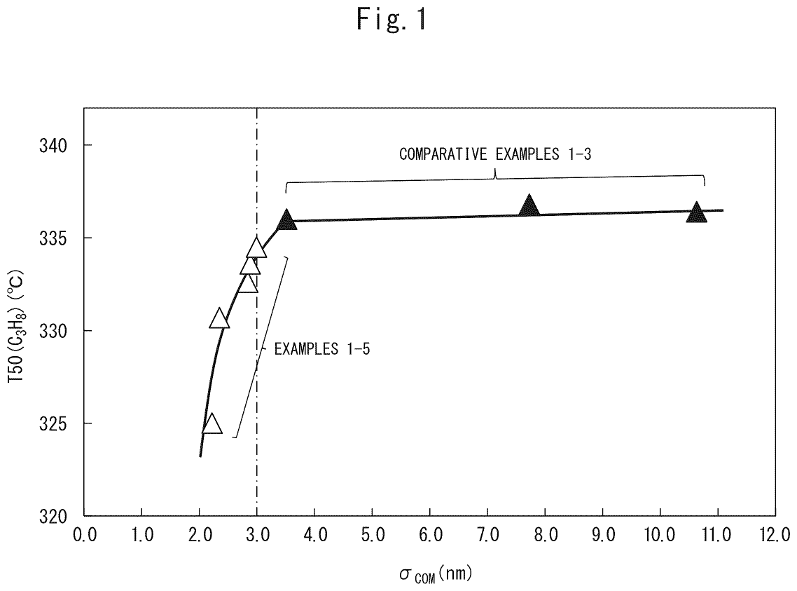

FIG. 1 is a graph showing the relationship between composition standard deviation σ_{COM} and propane 50% purification temperature (T50(C₃H₈)) for the noble metal catalyst particles of Examples 1 to 5 and Comparative Examples 1 to 3.

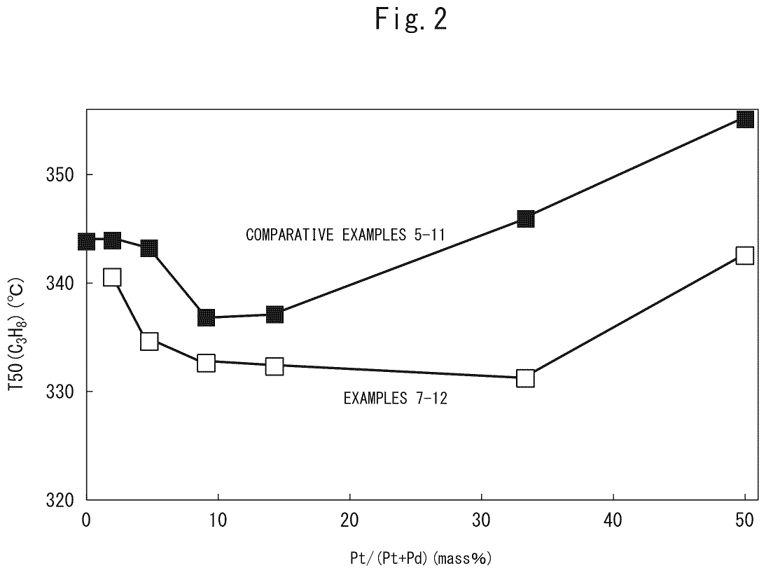

FIG. 2 is a graph showing the relationship between composition (Pt/(Pt+Pd) ratio) and propane 50% purification temperature (T50(C₃H₈)) for the noble metal catalyst particles of Examples 7 to 12 and Comparative Examples 5 to 11.

TABLE 1

| | Preparation of coprecipitate slurry | | | | | | | | | |
|---|---|---|---|---|---|---|---|---|---|---|
| | Reaction stock solution A | | | | | Reaction stock | | | | |
| | | | | | Pt/ | solution B | | TEAH/ | | Alumina |
| | Pt amount | | Pd amount | | (Pt + Pd) | TEAH amount | | (Pt + Pd) | | amount |
| | (g) | (mmol) | (g) | (mmol) | (mass %) | (g) | (mmol) | mol ratio | Reactor | (g) |
| Example 1 | 0.0909 | 0.466 | 0.909 | 8.54 | 9.10 | 10.61 | 72.07 | 8.0 | Micro reactor | 99.0 |
| Example 2 | 0.0909 | 0.466 | 0.909 | 8.54 | 9.10 | 7.96 | 54.04 | 6.0 | Micro reactor | 99.0 |
| Example 3 | 0.0909 | 0.466 | 0.909 | 8.54 | 9.10 | 5.31 | 36.04 | 4.0 | Micro reactor | 99.0 |
| Example 4 | 0.0909 | 0.466 | 0.909 | 8.54 | 9.10 | 2.65 | 18.02 | 2.0 | Micro reactor | 99.0 |
| Example 5 | 0.0909 | 0.466 | 0.909 | 8.54 | 9.10 | 1.33 | 9.01 | 1.0 | Micro reactor | 99.0 |
| Comp. Example 1 | 0.0909 | 0.466 | 0.909 | 8.54 | 9.10 | 15.92 | 108.10 | 12.0 | Flask | 99.0 |
| Comp. Example 2 | 0.0909 | 0.466 | 0.909 | 8.54 | 9.10 | 5.31 | 36.04 | 4.0 | Flask | 99.0 |
| Comp. Example 3 | 0.0909 | 0.466 | 0.909 | 8.54 | 9.10 | — | — | 0 | — | 99.0 |

TABLE 2

| | | | | | | | | | | Exhaust gas | |
|---|---|---|---|---|---|---|---|---|---|---|---|
| | | | | Noble metal catalyst particles | | | | | | purification | |
| | | | | Particle diameter | | | | Composition | | performance | |
| | Preparation of coprecipitate slurry | | | | | Standard deviation | | Standard deviation | | 50% purification | |
| | Pt/ | TEAH/ | | Average value (nm) | | σ_{rad} (nm) | | σ_{com} (mass %) | | temperature T50 | |
| | (Pt + Pd) | (Pt + Pd) | | | After | | After | | After | C₃H₈ | C₃H₆ |
| | (mass %) | mol ratio | Reactor | Initial | endurance | Initial | endurance | Initial | endurance | (° C.) | (° C.) |
| Example 1 | 9.10 | 8.0 | Micro reactor | 3.44 | 31.0 | 0.62 | 11.3 | 2.22 | 0.58 | 325.0 | 262.9 |
| Example 2 | 9.10 | 6.0 | Micro reactor | 3.52 | 31.9 | 0.83 | 10.7 | 2.35 | 0.80 | 330.7 | 263.6 |
| Example 3 | 9.10 | 4.0 | Micro reactor | 3.21 | 31.6 | 0.75 | 10.1 | 2.84 | 1.18 | 332.6 | 264.5 |
| Example 4 | 9.10 | 2.0 | Micro reactor | 3.85 | 31.2 | 0.94 | 10.5 | 2.88 | 1.51 | 333.6 | 264.2 |
| Example 5 | 9.10 | 1.0 | Micro reactor | 3.45 | 31.8 | 0.84 | 12.2 | 2.99 | 1.95 | 334.5 | 264.1 |
| Comp. Example 1 | 9.10 | 12.0 | Flask | 3.97 | 32.8 | 0.79 | 11.9 | 3.52 | 3.08 | 336.0 | 264.6 |
| Comp. Example 2 | 9.10 | 4.0 | Flask | 4.53 | 33.5 | 2.79 | 11.5 | 7.73 | 5.67 | 336.8 | 264.3 |
| Comp. Example 3 | 9.10 | 0.0 | — | 5.91 | 42.6 | 3.59 | 15.1 | 10.63 | 8.00 | 336.4 | 261.3 |

TABLE 3

| | Preparation of coprecipitate slurry | | | | | | | | | |
|---|---|---|---|---|---|---|---|---|---|---|
| | Reaction stock solution A | | | | | Reaction stock | | | | |
| | | | | | Pt/ | solution B | | TMAH/ | | Alumina |
| | Pt amount | | Pd amount | | (Pt + Pd) | TMAH amount | | (Pt + Pd) | | amount |
| | (g) | (mmol) | (g) | (mmol) | (mass %) | (g) | (mmol) | mol ratio | Reactor | (g) |
| Example 6 | 0.0909 | 0.466 | 0.909 | 8.54 | 9.10 | 3.29 | 36.04 | 4.0 | Micro reactor | 99.0 |
| Comp. Example 4 | 0.0909 | 0.466 | 0.909 | 8.54 | 9.10 | 3.29 | 36.04 | 4.0 | Flask | 99.0 |

TABLE 4

| | | | | Noble metal catalyst particles | | | | | | Exhaust gas purification | |
|---|---|---|---|---|---|---|---|---|---|---|---|
| | | | | Particle diameter | | | | Composition | | performance | |
| | Preparation of coprecipitate slurry | | | | | Standard deviation | | Standard deviation | | 50% purification | |
| | Pt/ | TMAH/ | | Average value (nm) | | σ_{rad} (nm) | | σ_{com} (mass %) | | temperature T50 | |
| | (Pt + Pd) | (Pt + Pd) | | | After | | After | | After | C₃H₈ | C₃H₆ |
| | (mass %) | mol ratio | Reactor | Initial | endurance | Initial | endurance | Initial | endurance | (° C.) | (° C.) |
| Example 6 | 9.10 | 4.0 | Micro reactor | 3.99 | 32.0 | 0.88 | 10.5 | 2.08 | 0.55 | 324.0 | 263.8 |
| Comp. Example 4 | 9.10 | 4.0 | Flask | 3.3 | 30.6 | 0.69 | 10.5 | 3.23 | 2.99 | 336.4 | 265.2 |

TABLE 5

| | Preparation of coprecipitate slurry | | | | | | | | | |
|---|---|---|---|---|---|---|---|---|---|---|
| | Reaction stock solution A | | | | | Reaction stock | | | | |
| | | | | | Pt/ | solution B | | TEAH/ | | Alumina |
| | Pt amount | | Pd amount | | (Pt + Pd) | TEAH amount | | (Pt + Pd) | | amount |
| | (g) | (mmol) | (g) | (mmol) | (mass %) | (g) | (mmol) | mol ratio | Reactor | (g) |
| Ref. Example 1 | 0 | 0 | 1.000 | 9.40 | 0 | 5.54 | 37.59 | 4.0 | Micro reactor | 99.0 |
| Example 7 | 0.0196 | 0.101 | 0.980 | 9.21 | 2.0 | 5.49 | 37.25 | 4.0 | Micro reactor | 99.0 |
| Example 8 | 0.0476 | 0.244 | 0.952 | 8.95 | 4.8 | 5.42 | 36.77 | 4.0 | Micro reactor | 99.0 |
| Example 9 | 0.0909 | 0.466 | 0.909 | 8.54 | 9.1 | 5.31 | 36.03 | 4.0 | Micro reactor | 99.0 |
| Example 10 | 0.1429 | 0.732 | 0.857 | 8.05 | 14.3 | 5.18 | 35.15 | 4.0 | Micro reactor | 99.0 |
| Example 11 | 0.3333 | 1.709 | 0.667 | 6.26 | 33.3 | 4.70 | 31.89 | 4.0 | Micro reactor | 99.0 |
| Example 12 | 0.5000 | 2.563 | 0.500 | 4.70 | 50.0 | 4.28 | 29.05 | 4.0 | Micro reactor | 99.0 |
| Comp. Example 5 | 0 | 0 | 1.000 | 9.40 | 0 | 5.54 | 37.59 | 4.0 | Flask | 99.0 |
| Comp. Example 6 | 0.0196 | 0.101 | 0.980 | 9.21 | 2.0 | 5.49 | 37.25 | 4.0 | Flask | 99.0 |
| Comp. Example 7 | 0.0476 | 0.244 | 0.952 | 8.95 | 4.8 | 5.42 | 36.77 | 4.0 | Flask | 99.0 |
| Comp. Example 8 | 0.0909 | 0.466 | 0.909 | 8.54 | 9.1 | 5.31 | 36.03 | 4.0 | Flask | 99.0 |
| Comp. Example 9 | 0.1429 | 0.732 | 0.857 | 8.05 | 14.3 | 5.18 | 35.15 | 4.0 | Flask | 99.0 |
| Comp. Example 10 | 0.3333 | 1.709 | 0.667 | 6.26 | 33.3 | 4.70 | 31.89 | 4.0 | Flask | 99.0 |
| Comp. Example 11 | 0.5000 | 2.563 | 0.500 | 4.70 | 50.0 | 4.28 | 29.05 | 4.0 | Flask | 99.0 |

TABLE 6

| | | | | | | | | | | Exhaust gas | |
|---|---|---|---|---|---|---|---|---|---|---|---|
| | | | | Noble metal catalyst particles | | | | | | purification | |
| | | | | Particle diameter | | | | Composition | | performance | |
| | Preparation of coprecipitate slurry | | | | | Standard deviation | | Standard deviation | | 50% purification | |
| | Pt/ | TEAH/ | | Average value (nm) | | σ_{rad} (nm) | | σ_{com} (mass %) | | temperature T50 | |
| | (Pt + Pd) | (Pt + Pd) | | | After | | After | | After | C₃H₈ | C₃H₆ |
| | (mass %) | mol ratio | Reactor | Initial | endurance | Initial | endurance | Initial | endurance | (° C.) | (° C.) |
| Ref. Example 1 | 0 | 4.0 | Micro reactor | 2.09 | 25.2 | 0.68 | 11.5 | — | — | 343.7 | 277.0 |
| Example 7 | 2.0 | 4.0 | Micro reactor | 2.06 | 28.2 | 0.99 | 10.9 | 1.38 | 1.22 | 340.5 | 270.0 |
| Example 8 | 4.8 | 4.0 | Micro reactor | 2.76 | 29.0 | 1.01 | 10.5 | 1.99 | 1.15 | 334.6 | 262.4 |
| Example 9 | 9.1 | 4.0 | Micro reactor | 3.21 | 31.6 | 0.75 | 10.1 | 2.84 | 1.18 | 332.6 | 264.5 |
| Example 10 | 14.3 | 4.0 | Micro reactor | 3.04 | 40.5 | 0.42 | 10.5 | 2.46 | 1.20 | 332.3 | 268.1 |
| Example 11 | 33.3 | 4.0 | Micro reactor | 3.53 | 53.5 | 0.65 | 9.9 | 2.08 | 1.19 | 331.2 | 278.5 |
| Example 12 | 50.0 | 4.0 | Micro reactor | 3.88 | 60.5 | 0.81 | 11.1 | 2.66 | 1.11 | 342.5 | 308.4 |
| Comp. Example 5 | 0 | 4.0 | Flask | 3.33 | 26.5 | 2.01 | 15.0 | — | — | 343.8 | 278.9 |
| Comp. Example 6 | 2.0 | 4.0 | Flask | 3.43 | 29.0 | 2.22 | 14.2 | 6.99 | 5.52 | 343.9 | 275.3 |
| Comp. Example 7 | 4.8 | 4.0 | Flask | 3.96 | 32.0 | 2.43 | 12.8 | 7.15 | 5.50 | 343.2 | 270.5 |
| Comp. Example 8 | 9.1 | 4.0 | Flask | 4.53 | 33.5 | 2.79 | 1.5 | 7.73 | 5.65 | 336.8 | 264.3 |
| Comp. Example 9 | 14.3 | 4.0 | Flask | 5.24 | 45.9 | 2.46 | 13.5 | 7.25 | 5.60 | 337.1 | 266.6 |
| Comp. Example 10 | 33.3 | 4.0 | Flask | 5.09 | 69.5 | 2.37 | 14.5 | 6.78 | 5.49 | 345.9 | 274.9 |
| Comp. Example 11 | 50.0 | 4.0 | Flask | 5.66 | 81.5 | 3.01 | 12.9 | 6.09 | 5.66 | 355.1 | 305.5 |

The following conclusions were drawn from the results in Tables 1 to 6 and FIGS. 1 and 2.

The supported catalysts for exhaust gas purification of Comparative Examples 1 to 4 and 7 to 11, which included noble metal catalyst particles having a composition standard deviation σ_{com} (initial value) of greater than 3.0 mass %, comprised Pt. However, these supported catalysts for exhaust gas purification had virtually no lowering of propane 50% purification temperature (T50(C₃H₈)) compared to the supported catalyst for exhaust gas purification of Comparative Example 5 which did not comprise Pt, and therefore exhibited essentially no increase in purification performance for saturated hydrocarbons (C₃H₈).

In contrast, the supported catalysts for exhaust gas purification of the invention (Examples 1 to 5 and 7 to 12), which included noble metal catalyst particles having a composition standard deviation σ_{com} (initial value) of 3.0 mass % or lower, and comprised Pt, exhibited enhanced purification performance for saturated hydrocarbons (C₃H₈) without impairment of purification performance for unsaturated hydrocarbons (C₃H₆). The enhanced purification performance for saturated hydrocarbons (C₃H₈) (lower propane 50% purification temperature (T50(C₃H₈)) by the supported catalysts for exhaust gas purification of the invention is shown prominently in FIG. 1 as well.

It was verified that this effect of the invention is exhibited across a wide range of Pt/(Pt+Pd) ratio for the noble metal catalyst particles and the TEHA/(Pt+Pd) ratio during production of the noble metal catalyst particles.

As seen in FIG. 2, in particular, when comparing with the same Pt/(Pt+Pd) ratio, it was verified that the supported catalysts for exhaust gas purification of the Examples, which included noble metal catalyst particles of the invention, had lower propane 50% purification temperatures (T50(C₃H₈)), and therefore enhanced purification performance for saturated hydrocarbons (C₃H₈), compared to the supported catalysts for exhaust gas purification of the Comparative Examples.

With the supported catalysts for exhaust gas purification of the Comparative Examples which included noble metal catalyst particles produced by a prior art method, the optimal range for the Pt/(Pt+Pd) ratio was relatively narrow. In contrast, with the supported catalysts for exhaust gas purification of the Examples which included noble metal catalyst particles produced by the method of the invention using a micro reactor, it was verified that a high level of purification performance for saturated hydrocarbons was exhibited across a wide range of Pt/(Pt+Pd) ratios.

Comparison with Example 6 and Comparative Example 4 confirmed that the effect of the invention is exhibited even when using TMAH instead of TEAH.

1.-12. (canceled)

13. Noble metal catalyst particles which are noble metal particles of an exhaust gas purification catalyst comprising an alloy containing Pt and Pd,
wherein the standard deviation σ_{COM} of the composition represented by the ratio of the Pt mass with respect to the total mass of Pt and Pd(Pt/(Pt+Pd)) in the noble metal catalyst particles is 3.0 mass % or lower.

14. The noble metal catalyst particles according to claim 13, wherein the standard deviation σ_{COM} of the composition is 2.5 mass % or lower.

15. The noble metal catalyst particles according to claim 13, wherein the composition (Pt/(Pt+Pd)) is 1.0 mass % or greater and 70 mass % or lower.

16. The noble metal catalyst particles according to claim 15, wherein the composition (Pt/(Pt+Pd)) is 3.0 mass % or greater and 40 mass % or lower.

17. The noble metal catalyst particles according to claim 13, wherein the mean particle size of the noble metal catalyst particles is 2.0 nm or greater and 5.0 nm or smaller.

18. The noble metal catalyst particles according to claim 17, wherein the standard deviation σ_{rad} of the particle diameters of the noble metal catalyst particles is 2.0 nm or lower.

19. The noble metal catalyst particles according to claim 18, wherein the standard deviation σ_{rad} of the particle diameters of the noble metal catalyst particles is 1.5 nm or lower.

20. The noble metal catalyst particles according to claim 13, wherein the coefficient of variation of the composition of the catalyst metal particles is 0.45 or lower.

21. The noble metal catalyst particles according to claim 15, wherein the coefficient of variation of the composition of the catalyst metal particles is 0.45 or lower.

22. The noble metal catalyst particles according to claim 17, wherein the coefficient of variation of the composition of the catalyst metal particles is 0.45 or lower.

23. The noble metal catalyst particles according to claim 18, wherein the coefficient of variation of the composition of the catalyst metal particles is 0.45 or lower.

24. A method for producing noble metal catalyst particles according to claim 13,
wherein the method comprises reacting a solution containing a Pt precursor and a Pd precursor with a solution containing an organic base, in a micro reactor.

25. The production method according to claim 24, wherein the organic base is selected from among amines and quaternary ammonium salts.

26. The production method according to claim 24, wherein the amount of the organic base is 0.5 times or greater and 10 times or less with respect to the total molar amount of Pt and Pd in the solution containing the Pt precursor and Pd precursor.

27. The production method according to claim 24, wherein the micro reactor is a flow-through reactor having a reaction volume of 0.01 mL or greater and 1.0 mL or lower at the reaction site where the solution containing the Pt precursor and Pd precursor and the solution containing the organic base are contacted.

28. The production method according to claim 24, wherein a heat transfer coefficient at the reaction site of the micro reactor is 1 MW/(m³·K) or higher and 500 MW/(m³·K) or lower.

29. A supported catalyst for exhaust gas purification, comprising:
inorganic oxide carrier particles, and
noble metal catalyst particles according to claim 13, supported on the inorganic oxide carrier particles.

30. The supported catalyst for exhaust gas purification according to claim 29, wherein the composition (Pt/(Pt+Pd)) is 1.0 mass % or greater and 70 mass % or lower.

31. The supported catalyst for exhaust gas purification according to claim 29, wherein the mean particle size of the noble metal catalyst particles is 2.0 nm or greater and 5.0 nm or smaller.

32. The supported catalyst for exhaust gas purification according to claim 29, wherein the standard deviation σ_{rad} of the particle diameters of the noble metal catalyst particles is 2.0 nm or lower.
